(19) United States
(12) Patent Application Publication
(10) Pub. No.: US 2004/0226878 A1
(43) Pub. Date: Nov. 18, 2004

(54) Overflow-catching shell for an oil or fuel filter

(76) Inventor: Kevin C. Higgins, Snohomish, WA (US)

Correspondence Address: Kevin C. Higgins, 17902 Interurban Blvd., Snohomish, WA, 98296, US

(21) Appl. No.: 10/438,544

(22) Filed: May 14, 2003

(51) Int. Cl. B01D 27/00

(52) U.S. Cl. 210/443

(57) ABSTRACT

A supplemental, overflow-catching shell 10 for a common oil or fuel filter 14 which surrounds the body of the filter 14 and captures otherwise lost oil or fuel upon removal of the filter 14 from a motor or other machinery. The shell 10 may be made of a rigid material and may have a flange 12 at its top of flexible, resilient material like rubber. The shell 10 may also be made of a flexible material and may be open at the top and closed at the bottom or may be open at both ends with a flexible, resilient-cincture sealing band 16 at the bottom and a flexible flange 12 at the top.

### BACKGROUND

1. Field of Invention

This invention relates to oil and fuel filters and a means of capturing and containing the overflow of oil or fuel incident to the removal of such filters from various machines.

2. Description of Prior Art

Many types of machinery including automobiles, boats, aircraft, manufacturing and processing machinery and others require oil or fuel filters or both. Regular maintenance of machinery includes the removal and replacement of these filters. An aggravating problem universally encountered in the removal of oil and fuel filters is that oil and fuel are lost between the filters and their mounting places on the machinery. This lost oil and fuel usually spills around the sides of the filters onto the hands of the person doing the removing, onto other parts of the machine, and onto the floor or ground where the vehicle or machine is positioned.

This lost oil and fuel creates serious health, safety, and environmental hazards.

### OBJECTS AND ADVANTAGES

Several objects and advantages of the present invention are as follows:

(a.) to provide a means of capturing and containing the overflow from oil and fuel filters incidental to their being removed from vehicle motors and other machinery;

(b.) to eliminate the health hazards caused by oil encountered by persons coming into contact with oil and fuel overflowing from oil and fuel filters;

(c.) to prevent the creation of safety hazards from oil and fuel running onto floors and decks;

(d.) to prevent the creation of serious environmental hazards caused by oil and fuel being lost on the ground, into drainage systems, into bilges of vessels, onto vehicle and machine parts, and onto roadways, etc.

Further objects and advantages include the elimination of the aggravation of having oil or fuel running onto a persons hands, arms and clothing during the removal of oil and fuel filters.

### DRAWING FIGURES

FIG. 1 shows a common oil or fuel filter with a permanently affixed, rigid, supplemental outer shell including a flexible annular flange on top for catching the overflow of oil or fuel upon removal of the filter from the machine to which it is mounted.

FIG. 2 shows a common oil or fuel filter with a removable, flexible, supplemental outer shell, including a flexible annular flange on top for catching the overflow of oil or fuel upon removal of the filter from the machine to which it is mounted and including a flexible sealing band at the bottom.

### REFERENCE NUMBERS IN DRAWINGS

10 shell

12 flexible flange

14 common standard oil or fuel filter

16 sealing band

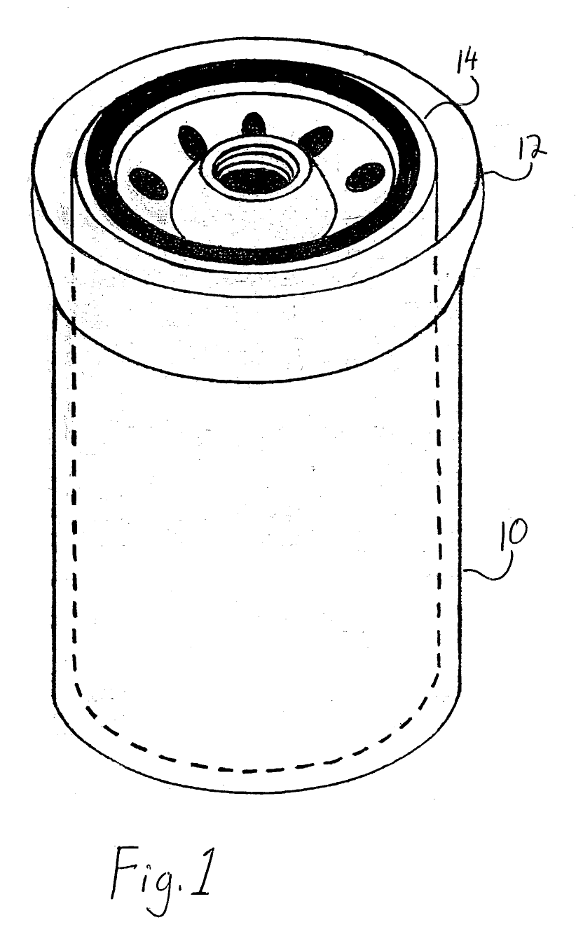

Description—FIG. 1

At typical embodiment of the overflow-catching shell of the present invention is illustrated in FIG. 1. The shell consists of a thin-walled rigid can-like structure, which surrounds and is larger in volume than the body of a common oil or fuel filter and is firmly attached thereto. The overflow-catching shell may be attached by soldering, welding, with screws, with adhesives, or by other means to the body of the common oil or fuel filter. The overflow-catching shell would typically be attached at the bottom of the common oil or fuel filter but might also have supplemental attachments on the sides with spacers between it and the body of the filter.

At the open top of the overflow-catching shell is attached a flexible and resilient annular flange of rubber or other material that will contact and conform to the surface to which the common oil or fuel filter mounts. The annular flange would typically extend slightly beyond the open end of the filter and may be bulbous, sloped, beveled, convoluted, incurvate, oblate, or salient in profile.

The overflow-catching shell and flange may be constructed in various sizes and profiles to accommodate various sizes and shapes of oil and fuel filters.

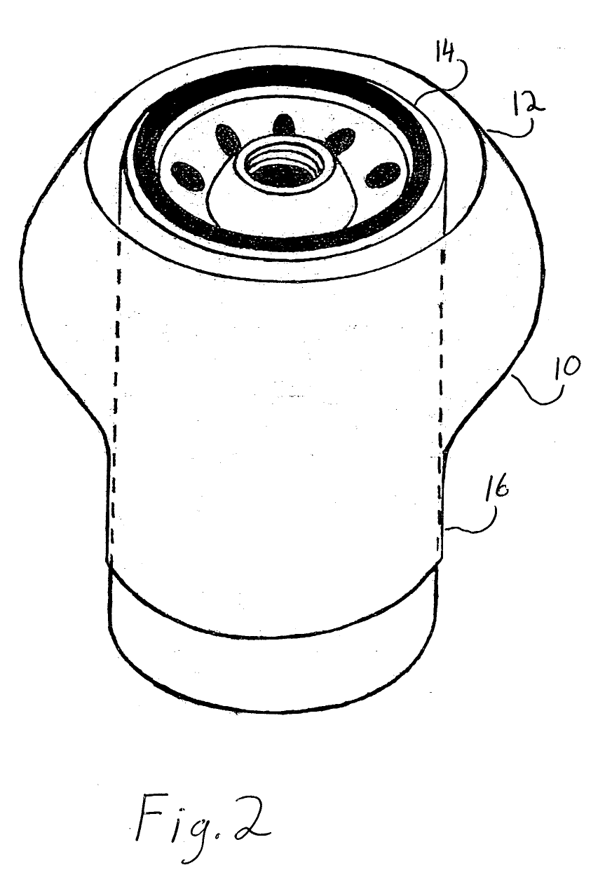

Description—FIG. 2

Another possible embodiment of the overflow-catching shell of the present invention is illustrated in FIG. 2. The shell consists of a flexible bulb-like structure, of rubber or similar material, which surrounds the body of the common oil or fuel filter and is removable and reusable. The overflow-catching shell in this embodiment is held onto the body of the oil or fuel filter by the gripping action of the flexible resilient annular sealing ring at the bottom of the shell.

The open top of the shell forms a flexible and resilient annular flange that will contact and conform to the surface to which the oil or fuel filter mounts. The annular flange would typically extend slightly beyond the open end of the filter and may have various profiles.

The overflow-catching shell, flange, and sealing ring might be constructed of various materials in various sizes and profiles to accommodate various sizes and shapes of filters.

The sealing ring at the bottom of the overflow-catching shell might be open for the bottom of the oil or fuel filter to pass through, as illustrated, or it might be closed and conform to the bottom of the filter.

Operation—FIG. 1

The manner of utilizing the overflow-catching filter shell is as follows. Shell 10 is attached to the outside of common oil or fuel filter 14 at the bottom and fully surrounds filter 14 except at the open end. Shell 10 and filter 14 are attached concentrically with shell 10 being approximately ten millimeters larger in diameter. Flexible flange 12 extends slightly beyond the open end of filter 14. Filter 14 is mounted to machinery or vehicle motor in the usual manner and performs its filtering function as usual. When filter 14 is removed from motor or machine to which it was mounted, flange 12 will conform to mounting surface and direct overflow oil or fuel into shell 10 thus preventing the oil or fuel from running onto the hands of the person removing filter 14 from the motor or machine. This capturing of the overflow oil or fuel also prevents it from being leaked onto exhaust pipes, drivelines, or other machine parts or onto driveways, roadways, etc.

Operation—FIG. 2

The manner of utilizing the overflow-catching shell illustrated in FIG. 2 is as follows. Shell 10 is slid onto the body of the common oil or fuel filter 14 and is held in place by the gripping action of the resilient sealing ring 16. Shell 10 is pushed far enough up the body of filter 14 that flexible flange 12 contacts and conforms to the surface to which filter 14 is mounted. When filter 14 is removed from the motor or machine to which it was mounted, flange 12 will conform to mounting surface and direct overflow oil or fuel into shell 10 thus preventing oil or fuel from running onto the hands of the person removing filter 14 from the motor or machine. Sealing ring 16 will prevent the oil from running out the bottom of shell 10 in an open-bottomed embodiment of the invention.

Summary, Ramifications, and Scope

Accordingly, the reader will see that the overflow-catching shell of this invention would be a significant improvement in the design of oil and fuel filters used on vehicles and machinery. In most applications it would capture most or all of the oil or fuel lost during the removal of common oil and fuel filters. The effectiveness of the invention would depend partly on the degree of verticality at which the oil or fuel filter is mounted.

By catching the lost oil or fuel, the overflow-catching shell of this invention solves several problems incidental to the removal of oil and fuel filters in that

it eliminates the aggravation of having oil or fuel run onto a persons hands and clothing;

it eliminates the health hazards of coming into contact with petroleum products;

it keeps the adjacent surfaces of the vehicles and machinery free of spilled oil or fuel;

it keeps lost oil and fuel from contaminating floors, driveways, roadways, and other ground surfaces; and

it significantly reduces the amount of petroleum contamination of streams, rivers, lakes, and other bodies of water, with great environmental benefit.

Although the description above contains several specificities, these should not be construed as limiting the scope of the invention but as merely providing illustrations of some of the possible embodiments of the invention. For example, the overflow-catching shell might be alternately more bulbous in shape or less concentrically attached to the oil or fuel filter, or may be longer or shorter in relation to the length of the filter. The overflow-catching shell might be less than the full length of the filter and only attached around the circumference thereof rather than at the bottom. The shell might have grip-enhancing surfaces or volutions. The annular flexible flange might have various profiles and proportions relative to the shell or may be eliminated in some embodiments. The shell might be manufactured of various materials or may be a single piece of one material. The shell and flange might be manufactured as an integral part of the oil or fuel filter or as a separate, attachable, detachable, and reusable unit, and may be held to the filter solely by friction. In an open-bottomed embodiment of the invention the sealing band at the bottom might have multiple cinctures or might have mechanical attachments for sealing such as round clamps.

Thus the scope of the invention should be determined by the appended claims and their legal equivalents, rather than by the examples given.

I claim:

1. A supplemental outer shell for an oil or fuel filter, which captures otherwise lost oil or fuel upon removal of said filter from a motor or other machinery.

2. The supplemental shell of claim 1 wherein said shell is permanently attached to said oil or fuel filter.

3. The supplemental shell of claim 1, which includes an annular flexible and resilient flange to direct lost oil or fuel into said shell.

4. The supplemental shell of claim 1, which is removable from said oil or fuel filter and is reusable.

5. The supplemental shell of claim 1, which is manufactured partly of rigid material and partly of flexible material.

6. The supplemental shell of claim 1 manufactured entirely of flexible material.

7. The supplemental shell of claim 1 with a closed bottom.

8. The supplemental shell of claim 1 with an open bottom and an annular sealing ring.
